(19) United States
(12) Patent Application Publication
(10) Pub. No.: US 2008/0274235 A1
(43) Pub. Date: Nov. 6, 2008

(54) Products from biofuel manufacturing process

(75) Inventors: Keith A. Kor, Le Seur, MN (US); Verle Richard Lunz, Fairmont, MN (US)

Correspondence Address: SCHWEGMAN, LUNDBERG & WOESSNER, P.A., P.O. BOX 2938, MINNEAPOLIS, MN, 55402, US

(73) Assignee: Corn Plus, LLLP

(21) Appl. No.: 11/800,529

(22) Filed: May 4, 2007

(51) Int. Cl. C10L 8/00; A23K 1/14

(52) U.S. Cl. 426/54; 44/300

(57) ABSTRACT

Embodiments of the invention relate to a method of providing value-added byproducts from a biofuel process, comprising fermenting a biofuel source sufficient to provide a biofuel and a mash mixture, separating the mixture sufficient to provide a biofuel and a mash, separating the mash sufficient to provide wet distillers grain (WDG) and a syrup, heating the syrup sufficient to provide ash, binding the ash sufficient to provide a solid ash, drying the wet distillers grain (WDG) sufficient to provide dried distillers grain (DDG) and binding the dried distillers grain sufficient to provide a solid dried distillers grain (DDG).

### PRIORITY OF INVENTION

This non-provisional application claims the benefit of priority under 35 U.S.C. § 119(e) to U.S. Provisional patent application Ser. No. 11/429,185, filed May 5, 2006, which is herein incorporated by reference.

### TECHNICAL FIELD

Embodiments of the present invention relate to value-added products from a biofuel production process. Specifically, embodiments of the invention relate to value-added products, such as solid ash or solid dried distillers grain (DDG), produced from an ethanol manufacturing process.

### BACKGROUND

The development and incentives for the use of renewable energy is a key component of many governmental political strategies. Americans alone consume more than 20 million barrels of oil a day. Currently, the United States imports more than two thirds of the oil it utilizes. Ethanol manufacturing from corn and other biomass sources is a subject of great interest at many levels of government. The main drawback of modem ethanol technologies is the neglect of additional value-added products that can be successfully produced parallel to ethanol manufacturing. One of the typical by-products, dried distillers grains and solubles (DDGS), may be sold as animal feed, but is not usually considered an economically viable by-product as its nutritional quality and price is not competitive with conventional soybean feed in many parts of the country. The DDGS also has a short shelf life, making it difficult to market as a feed product.

Another undesirable consequence of biofuel production is the air pollution associated with the drying of distillers grains and burning of syrup. Most conventional processes use a hot stream of air or thermal oxidizer to dry the distillers grains or syrup, which is then vented to the atmosphere releasing potentially harmful chemicals. Further, conventional biofuel production processes have substantial inefficiencies, both economically and in terms of energy consumption.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a block flow diagram of a method of producing solid ash from a biofuel process, according to some embodiments.

FIG. 2 illustrates a block flow diagram of a method of producing solid dried distillers grain (DDG) from a biofuel process, according to some embodiments.

FIG. 3 illustrates a block flow diagram of a method of producing solid ash and solid dried distillers grain (DDG) from a biofuel process, according to some embodiments.

FIG. 4 illustrates a block flow diagram of a method of producing solid ash and solid dried distillers grain with solubles (DDGS) from a biofuel process, according to some embodiments.

FIG. 5 illustrates a block flow diagram of a method of producing recovered heat for powering a biofuel process, according to some embodiments.

FIG. 6 illustrates a schematic of a method of producing value-added products from a biofuel process, according to some embodiments.

FIG. 7 illustrates a schematic of a method of generating revenue from the production of value-added products from a biofuel process, according to some embodiments.

### SUMMARY

Embodiments of the present invention relate to a method of providing a solid ash from a biofuel process. The method comprises fermenting a biofuel source sufficient to provide a biofuel and a mash mixture, separating the mixture sufficient to provide a biofuel and a mash, separating the mash sufficient to provide wet distillers grain (WDG) and a syrup, heating the syrup sufficient to provide ash and binding the ash sufficient to provide a solid ash.

Embodiments of the present invention also relate to a method of providing a solid dried distillers grain (DDG) from a biofuel process. The method comprises fermenting a biofuel source sufficient to provide a biofuel and a mash mixture, separating the mixture sufficient to provide a biofuel and a mash, separating the mash sufficient to provide wet distillers grain (WDG) and a syrup, drying the wet distillers grain (WDG) sufficient to provide dried distillers grain (DDG) and binding the dried distillers grain sufficient to provide a solid dried distillers grain (DDG).

Embodiments of the present invention also relate to methods of producing both solid ash and solid DDG from a biofuel manufacturing process. Further methods described include embodiments to a method for producing a biofuel, comprising fermenting a biofuel source sufficient to provide a biofuel and a mash mixture, separating the mixture sufficient to provide a biofuel and a mash, separating the mash sufficient to provide wet distillers grain (WDG) and a syrup and heating the syrup with a fluidized bed sufficient to provide ash and heat. The heat is recovered for use in powering plant processes. Embodiments also include a method of generating revenue from a biofuel manufacturing process.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Embodiments of the invention relate to value-added products from a biofuel manufacturing process. By utilizing a fluidized bed of sand to burn excess syrup from a biofuel process, a number of energy and/or economical efficiencies are achieved in the manufacturing process. The dried distillers grains (DDG) may have a lower oil content, allowing them to be solidified and used as a further fuel source and value-added byproduct, such as stove pellets. The solid DDG (or even solid DDGS) has a higher energy density than traditional DDGS produced from a biofuel process, allowing for easier transportation, packaging and ultimately, its economic viability as a retail product.

The ash produced from heating the syrup may also be solidified and utilized as an all-natural fertilizer or counter-pollution product. The fertilizer may be bound in many shapes, sizes, textures, etc. to be sold in multiple markets. Such markets may include agricultural, landscaping, residential and commercial lawn care and for sporting facilities, such as golf courses and sporting fields. The solid ash may also be utilized in environmental applications. The basic pH and chemical properties of the solid ash may be optimal for remedying polluted water and soil. Heating the syrup to produce ash also creates heat that may be recovered and utilized for many of the processes in manufacturing the biofuel. This cogeneration of energy reduces a biofuel plant's energy needs, lowering the cost to produce the biofuel.

### DEFINITIONS

As used herein, “biofuel source” refers to any substance or mixture from which a renewable fuel may be manufactured. A biofuel source may be biomass, such as any organic, non-fossil plant material. Corn, switchgrass, palm oil, rapeseed, soybeans, straw, manure, sugarcane and wood may be examples.

As used herein, “biofuel” refers to a fuel derived from a renewable source, usually organic in nature. A biofuel may be manufactured from biomass, for example. Examples of biofuels may be ethanol, butanol and biodiesel.

As used herein, “fermentation” refers to the chemical conversion of carbohydrates into alcohols or acids. Carbohydrates, or sugars, may be converted to alcohol under anaerobic conditions in the presence of yeast. An example of an alcohol produced by this process is ethanol.

As used herein, “mash” refers to a mixture, at least partially liquefied, that may be present at multiple stages in a biofuel manufacturing process. Mash may change composition depending on what stage in the process it is being described as, but generally includes the components of the biofuel source mixture once the biofuel has been removed. For example, a corn-based mixture may be distilled to remove ethanol, with the remainder of the mixture labeled as mash.

As used herein, “ash” refers to the unburnable remains of heating or burning. Ash may also refer to the residual product after incineration. Heating syrup in a fluidized bed as part of a biofuel manufacturing process may create ash, for example.

As used herein, “syrup” refers to the remainder of the distillation product after evaporation in a biofuel production process. A syrup may contain about 25-50% solids, about 30-45% or about 30-35% solids and may be blended with wet distillers grains, used as an animal feed, used as binder or heated to produce ash.

As used herein, “wet distillers grains (WDG)” refers to the product obtained after the removal of a biofuel by distillation from the yeast fermentation of a biofuel source. Wet distillers grain may also refer to the portion separated after the distillation that does not contain a significant amount of syrup.

As used herein, “dried distillers grain (DDG)” refers to the product obtained after removing at least a portion of the liquid material from wet distillers grain (WDG).

As used herein, “dried distillers grains and solubles (DDGS)” refers to the product obtained after the removal of a biofuel by distillation from the yeast fermentation of a biofuel source by condensing and/or drying at least about ¾ of the solids by the methods employed in the biofuel industry.

As used herein, “separating” refers to removing a component from a mixture or combination, or to isolate.

As used herein, “binding” refers to holding two or more materials together, such as by adhesion, cohesion or both. Binders accomplish the binding of two or more materials. Lignum sulfate is an example of a binder used to form solid dried distillers grain (DDG).

As used herein, “solid ash”, “solid dried distillers grain (DDG)” and “solid dried distillers grain with solubles (DDGS)” refer to the bound version of the material. For example, solid ash refers to bound ash or ash that is held together in a desired shape or form.

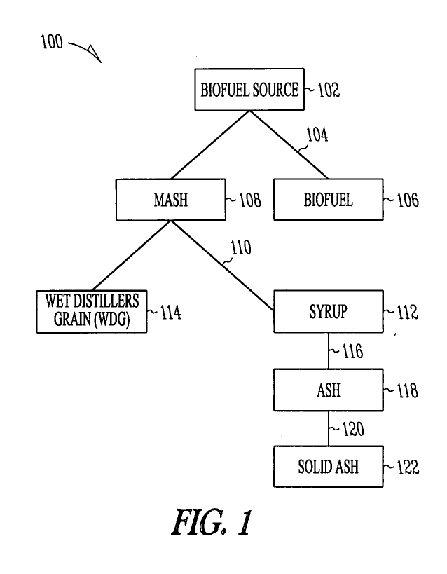

Referring to FIG. 1, a block flow diagram of a method 100 of producing solid ash from a biofuel process is shown, according to some embodiments. A biofuel source 102 may be fermented 104 to produce a biofuel 106 and mash 108. The mash 108 may be separated 110 to produce wet distillers grain (WDG) 114 and syrup 112. The syrup 112 may be heated 116 to produce ash 118. The ash 118 may be bound 120 to provide solid ash 122.

A biofuel source 102 may be corn, for example. The biofuel source 102 may also be a substance containing cellulose, such as switchgrass. The biofuel 106 may be ethanol or butanol, for example.

Fermenting 104 refers to the chemical conversion of carbohydrates into alcohols or acids. The step of fermentation 104 may generally include any number of preparatory steps in converting the carbohydrates from a biofuel source 102 to a biofuel 106 and mash 108. Such steps may include, e.g., grinding, mixing, reacting with enzymes, heating, cooling, storing, cooking, undergoing saccharification, etc.

The mash 108 may be a mixture, at least partially liquefied, that may be present at multiple stages in a biofuel manufacturing process. Mash 108 may change composition depending on what stage in the process it is being described as, but generally includes the components of the biofuel source mixture once the biofuel has been removed.

Separation 110 may be accomplished by centrifuge, for example. Separation 110 may be accomplished by any means that extracts the syrup 112 from the WDG 114. Syrup 112 may refer to the remainder of the distillation product after evaporation in a biofuel production process. The syrup 112 may contain about 25-50% solids, about 30-45% or about 30-35% solids, about for example.

Heating 116 the syrup 112 may include methods that generate ash while also producing recoverable heat. A fluidized bed of sand may be used to heat 116 the syrup 112, which produces ash 118. The ash 118 may include phosphorus, potassium, calcium and manganese, for example. The ash 118 content may vary based on the original biofuel source, such as corn or switchgrass. By using a fluidized bed to heat 116, potentially harmful chemicals are not released to the environment as when a thermal oxidizer is utilized, for example.

Binding 120 the ash 118 may be accomplished by utilization of an extruder, compressor or pelletizer, for example, to produce solid ash 122. The solid ash 122 may be bound by such binders as protein colloids, carboxylmethyl cellulose, lignosulfonate-starch blends, urea formaldehyde resins, wheat gluten, calcium salts and collagen, for example. A sufficient amount of syrup 112 may also be routed to the binding mechanism and utilized as a binder. The syrup 112 may also increase the energy density of the solid ash 122. The syrup 112 may comprise about 1 to about 20% by weight of the solid ash 118, for example.

Binders may assist in the solid ash 122 maintaining a specific shape or form, for example. The solid ash 122 may be bound 120 to form pellets or small spheres. Without binding 120 the ash 118, the ash 118 maintains a powdery form that is difficult to handle and transport.

Because the solid ash 122 may include such valuable components as phosphorus, potassium, calcium and manganese, it may be utilized and sold as a fertilizer. The solid ash 122 may also maintain a basic pH that assists in regulating optimum soil chemistry and equilibrium. The solid ash 122 may be bound and shaped to differing sized based on the fertilizer application desired. The shape may be determined on whether the fertilizer will be used in a commercial spreader or a hand-held unit, for example. The solid ash 122 may be formed into pellets of about 1 mm³ to about 1 cm³, about 0.5 mm³ to about 2 cm³, or about 100 mm³ to about 600 mm³, for example.

In addition to the ash 118 and binder, the solid ash 122 may have additional components added to it. Such components may be soil nutrients, stabilizers and colorants, for example. The solid ash 122 may be customized based on a customer's needs, for example. Specific micronutrients could be added and a desired shape or size formed.

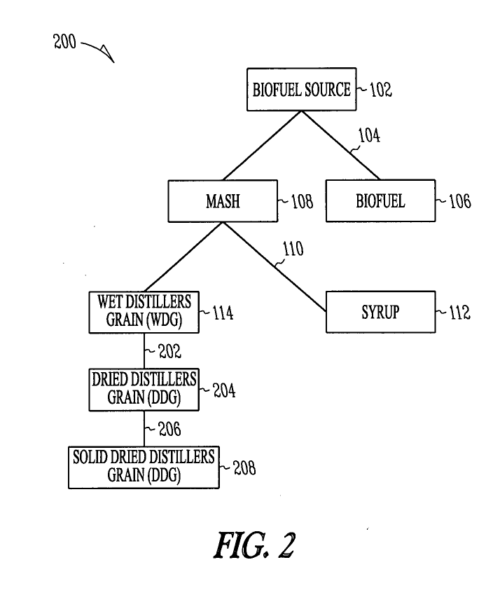

Referring to FIG. 2, a block flow diagram of a method 200 of producing solid dried distillers grain from a biofuel process is shown, according to some embodiments. A biofuel source 102 may be fermented 104 to produce a biofuel 106 and mash 108. The mash 108 may be separated 110 to produce wet distillers grain (WDG) 114 and syrup 112. The WDG 114 may be dried 202 to produce dried distillers grain (DDG) 204. The DDG 204 may be bound 206 to produce solid dried distillers grain (DDG) 208.

Wet distillers grain (WDG) 114 refers to the product obtained after the removal of a biofuel by distillation from the yeast fermentation of a biofuel source. Wet distillers grain may also refer to the portion separated after the distillation that does not contain a significant amount of syrup.

Dried distillers grain (DDG) 204 refers to the product obtained after removing at least a portion of the liquid material from wet distillers grain (WDG) 114. Binding 206 the DDG 204 may be accomplished by utilization of an extruder, compressor or pelletizer, for example, to produce solid DDG 208. The solid DDG 208 may be bound by such binders as protein colloids, carboxylmethyl cellulose, lignosulfonate-starch blends, urea formaldehyde resins, wheat gluten, calcium salts and collagen, for example. A sufficient amount of syrup 112 may also be routed to the binding mechanism and utilized as a binder. Binders may assist in the solid DDG 208 maintaining a specific shape or form, for example. The solid DDG 208 may be bound 120 to form pellets or other shapes. The solid DDG 208 may be formed into pellets ranging from about 0.5 mm³ to about 2 in³, about 100 mm³ to about 1 in³, or about 1 cm³ to about 0.5 in³, for example.

Solid dried distillers grain (DDG) 208 refers to the bound DDG. Solid DDG 208 may have a lower oil content than other solid or pelletized distillers grains, which facilitates its binding. The solid DDG 208 may be burned as a solid fuel, such as in a pellet stove or corn-burning stove. With the lessened oil content, the solid DDG 208 burns cleaner than other pelletized distillers grains. The solid DDG 208 may have a moisture content of less than about 15%, less than about 12% or less than about 10%, for example. In addition, the lessened oil content allows the solid DDG 208 to bind easier as the oil interferes with forming and maintaining stable forms, such as pellets. The solid DDG 208 may also have an increased energy density over other solid distillers grains.

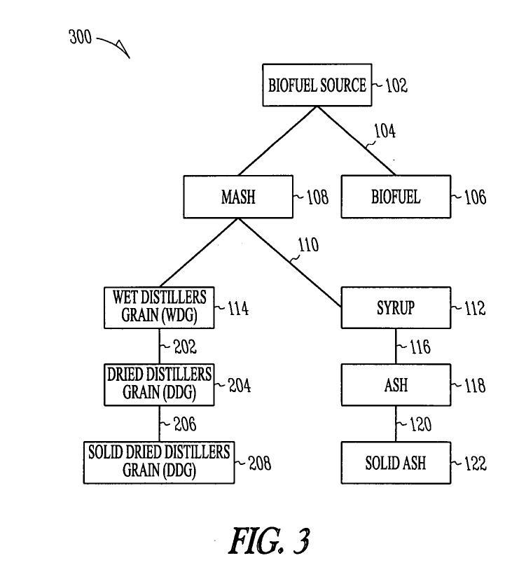

Referring to FIG. 3, a block flow diagram of a method 300 of producing solid ash and solid dried distillers grain from a biofuel process is shown, according to some embodiments. A biofuel source 102 may be fermented 104 to produce a biofuel 106 and mash 108. The mash 108 may be separated 110 to produce wet distillers grain (WDG) 114 and syrup 112. The syrup 112 may be heated 116 to produce ash 118. The ash 118 may be bound 120 to provide solid ash 122. The WDG 114 may be dried 202 to produce dried distillers grain (DDG) 204. The DDG 204 may be bound 206 to produce solid dried distillers grain (DDG) 208. Both solid ash 122 and solid DDG 208 may be produced as byproducts of a biofuel manufacturing process.

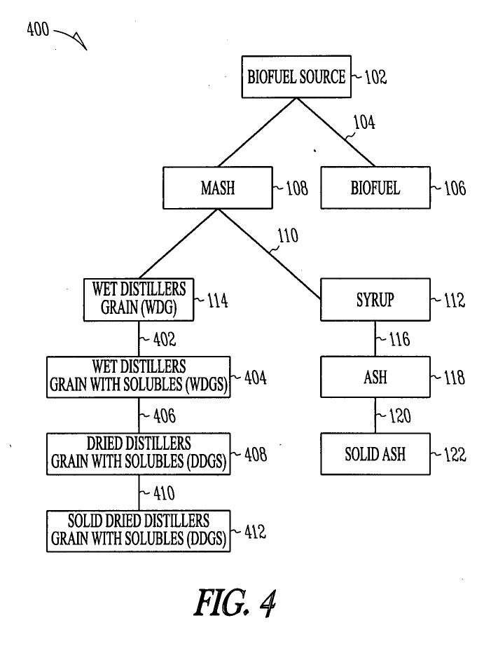

Referring to FIG. 4, a block flow diagram of a method 400 of producing solid ash and solid dried distillers grain with solubles from a biofuel process is shown, according to some embodiments. A biofuel source 102 may be fermented 104 to produce a biofuel 106 and mash 108. The mash 108 may be separated 110 to produce wet distillers grain (WDG) 114 and syrup 112. The syrup 112 may be heated 116 to produce ash 118. The ash 118 may be bound 120 to provide solid ash 122. Solubles may be added 402 to the WDG 114 to produce wet distillers grain with solubles (WDGS) 404. The WDGS 404 may be dried 406 to produce dried distillers grain with solubles (DDGS) 408. The DDGS 408 may be bound 410 to produce solid dried distillers grain with solubles (DDGS) 412.

Dried distillers grain with solubles (DDGS) 408 refers to the product obtained after the removal of a biofuel by distillation from the yeast fermentation of a biofuel source by condensing and/or drying at least about ¾ of the solids by the methods employed in the biofuel industry. Solid dried distillers grain with solubles (DDGS) 412 refers to bound DDGS. Similar to the methods described in FIGS. 1-3, solid DDGS may be produced as part of a biofuel process when it may be desirable not to remove the solubles or add solubles to the dried distillers grain.

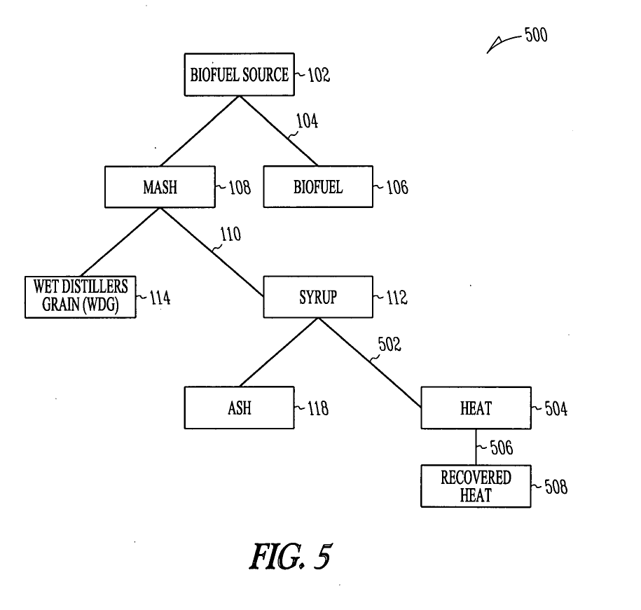

Referring to FIG. 5, a block flow diagram of a method 500 of producing recovered heat for powering a biofuel process is shown, according to some embodiments. A biofuel source 102 may be fermented 104 to produce a biofuel 106 and mash 108. The mash 108 may be separated 110 to produce wet distillers grain (WDG) 114 and syrup 112. The syrup 112 may be heated 116 to produce ash 118 and heat 504. The heat 504 may be recovered 506, providing recovered heat 508.

The heat 504 may be recovered 506, such as in a recovery boiler, and used as power or heat for other biofuel manufacturing components. This reduces the energy consumption of the biofuel plant and increases its energy efficiency and therefore, its economic efficiency. The recovered heat 508 may be used in a steam boiler, cook tank, heaters, still, evaporator and dryers, for example.

### EXAMPLE

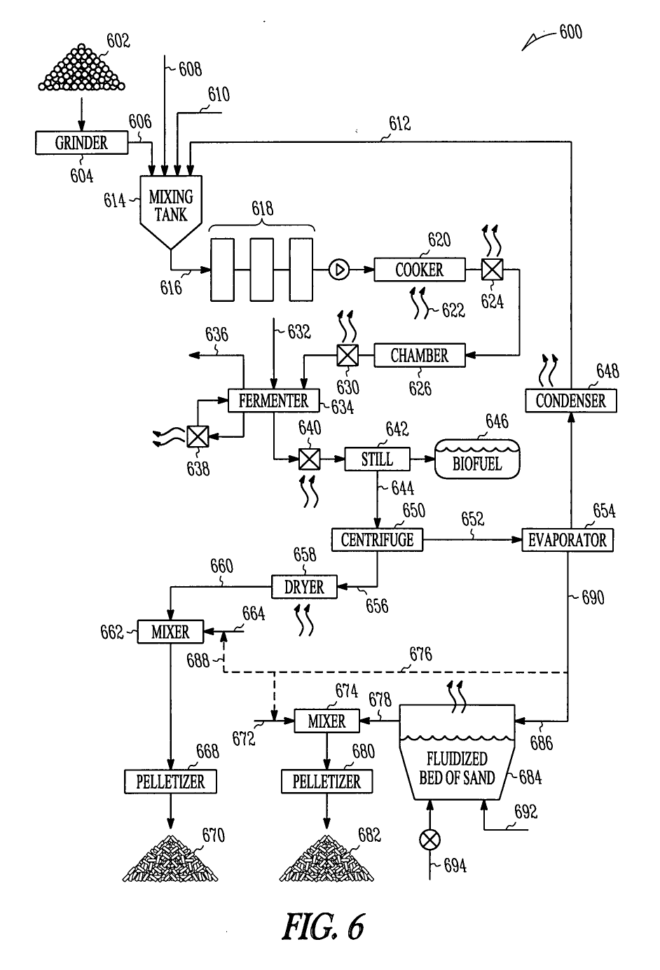

Referring to FIG. 6, a schematic of a method 600 of producing value-added products from a biofuel process is shown, according to some embodiments. A biofuel source 602 may be reduced in size in a grinder 604. The ground biofuel source 606 may be introduced into mixing tank 614. In addition, enzymes 610, hot water condensate 612 and other chemicals 608, such as aqueous ammonia, may be added to the mixing tank 614. Alpha amylase may be an example of an enzyme added to the tank 614.

After undergoing physical reactions, chemical reactions or both, a mixture 616 is formed. The mixture 616, which may be a liquid faction, may then be held in one or more holding tanks 618. The mixture 616 may be held for a varying amount of time, sufficient for a desired chemical reaction to occur, such as enzymes breaking down starches and complex carbohydrates to dextrin, for example.

The mixture 616 may then be contacted with heat 622 in a cooker 620. The cooker 620 may assist in sterilizing the mixture 616. The mixture 616 may then be cooled in a cooler 624 before undergoing saccharification in chamber 626 (in contact with enzymes 628). Saccharification may accomplish the conversion of complex carbohydrates or dextrin in the mixture 616 to glucose, for example. Glucoamylase may be an example of enzyme 626. The cooler 624 may be any type of heat exchanger, such as a water cooled heat exchanger that receives cooled water from a cooling tower, for example.

The temperature of the mixture 616 may then be reduced in cooler 630 before entering the fermenter 634. Yeast 632 is introduced to the fermenter 634 to facilitate the fermentation of the mixture 616. Fermentation is the chemical conversion of carbohydrates into alcohols or acids. A recirculating cooler 638 may be in contact with the fermenter 634, which assists in controlling the temperature of reaction. Carbon dioxide 636 may be released from the fermenter 634 and utilized as a valuable byproduct of the reaction.

Once the mixture 616 leaves the fermenter 634 it may be heated by heater 640 before entering the still 642, where it may be further heated and then distilled. The heater 640 may be a steam-driven heat exchanger, for example. A biofuel 646 may then separated from the mash 644. The biofuel 646 may be ethanol.

The mash 644 is then separated in a centrifuge 650, producing wet distillers grain (WDG) (first portion) 656 and a liquid portion 652 (second portion). The liquid portion 652 is then introduced to evaporator 654 producing a syrup solution 690 and moisture to be condensed into condenser 648. The liquid portion 652 may be comprised mostly of water with some solid material. The WDG 656 has a higher solid/liquid ratio (mixture's weight of solid material divided by the mixture's weight of liquid). The output of the condenser 648 may be hot water condensate that is recycled back to the mixing tank 614.

The WDG 656 may then be introduced to a dryer 658 which produces dried distillers grain (DDG) 660. The DDG 660 may be contacted with a binder 664 in mixer 662 and introduced to a pelletizer 668. The pelletizer 668 may then bind the DDG and binder to form a pelletized DDG 670. The binder may be lignum sulfate, for example.

The syrup solution 690 may continue as in-line syrup 686 to a fluidized bed of sand 684. Combustion air 692 and natural gas 694 may be utilized to heat the in-line syrup 686, which generates heat and ash 678. The ash 678 may be contacted with a binder 672 in a mixer 674. The mixture may then be introduced to a pelletizer 680, forming pelletized ash 682.

Alternatively or in conjunction, some of the syrup 690 may be utilized as an addition 688, 676 to the binders 664, 672 in facilitating the palletizing of the DDG and ash, respectively.

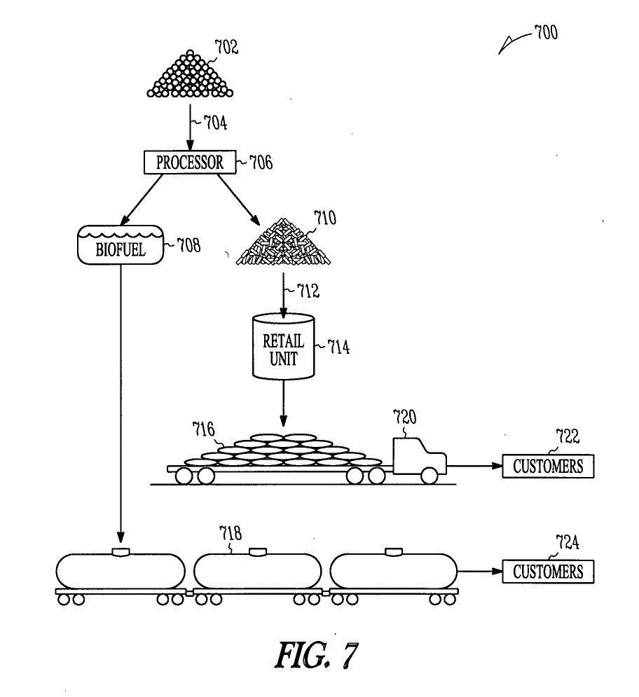

Referring to FIG. 7, a schematic of a method 700 of generating revenue from the production of value-added products from a biofuel process, according to some embodiments. A biofuel source 702 may be ground 704 and processed 706 to produce a biofuel 708 and one or more value-added byproducts 710. The biofuel 708 may be transported 718 and sold to customers 724. The value-added byproducts 710 may be bound to form solid byproducts and packaged 712 into a retail unit 714. The byproducts 710 may have an increased density over non-bound byproducts of a biofuel process, which increases the transportation value. The units 714 may be loaded 716 and transported 720 to be sold to customers 722.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

What is claimed is:

1. A method of providing a solid ash from a biofuel process, comprising:
fermenting a biofuel source, sufficient to provide a biofuel and a mash mixture;
separating the mixture, sufficient to provide a biofuel and a mash;
separating the mash, sufficient to provide wet distillers grain (WDG) and a syrup;
heating the syrup, sufficient to provide ash; and
binding the ash, sufficient to provide a solid ash.

2. The method of claim 1, wherein the biofuel comprises ethanol.

3. The method of claim 1, wherein the biofuel source comprises corn.

4. The method of claim 1, wherein the biofuel source comprises a cellulose source.

5. The method of claim 1, wherein heating comprises burning with a fluidized bed of sand.

6. The method of claim 1, wherein binding comprises pelletizing.

7. The method of claim 1, wherein binding comprises extruding.

8. The method of claim 1, wherein the solid ash comprises pelletized ash.

9. A method of providing a solid dried distillers grain (DDG) from a biofuel process, comprising:
fermenting a biofuel source, sufficient to provide a biofuel and a mash mixture;
separating the mixture, sufficient to provide a biofuel and a mash;
separating the mash, sufficient to provide wet distillers grain (WDG) and a syrup;
drying the wet distillers grain (WDG), sufficient to provide dried distillers grain (DDG); and
binding the dried distillers grain, sufficient to provide a solid dried distillers grain (DDG).

10. The method of claim 9, wherein the biofuel comprises ethanol.

11. The method of claim 9, wherein the biofuel source comprises corn.

12. The method of claim 9, wherein the biofuel source comprises a cellulose source.

13. The method of claim 9, wherein heating comprises burning with a fluidized bed of sand.

14. The method of claim 9, wherein binding comprises pelletizing.

15. The method of claim 9, wherein binding comprises extruding.

16. The method of claim 9, wherein the solid DDG comprises pelletized DDG.

17. A method of providing value-added byproducts from a biofuel process, comprising:
fermenting a biofuel source, sufficient to provide a biofuel and a mash mixture;
separating the mixture, sufficient to provide a biofuel and a mash;
separating the mash, sufficient to provide wet distillers grain (WDG) and a syrup;
heating the syrup, sufficient to provide ash;
binding the ash, sufficient to provide a solid ash;
drying the wet distillers grain (WDG), sufficient to provide dried distillers grain (DDG); and
binding the dried distillers grain, sufficient to provide a solid dried distillers grain (DDG).

18. The method of claim 17, wherein the biofuel comprises ethanol.

19. The method of claim 17, wherein the biofuel source comprises corn.

20. The method of claim 17, wherein the biofuel source comprises a cellulose source.

21. The method of claim 17, wherein heating comprises burning with a fluidized bed of sand.

22. The method of claim 17, wherein binding comprises pelletizing.

23. The method of claim 17, wherein binding comprises extruding.

24. The method of claim 17, wherein solid DDG comprises pelletized DDG.

25. The method of claim 17, wherein solid ash comprises pelletized ash

26. A method of providing value-added byproducts from a biofuel process, comprising:
fermenting a biofuel source, sufficient to provide a biofuel and a mash mixture;
separating the mixture, sufficient to provide a biofuel and a mash;
separating the mash, sufficient to provide wet distillers grain (WDG) and a syrup;
heating the syrup, sufficient to provide ash;
binding the ash, sufficient to provide a solid ash;
adding solubles to the wet distillers grain, sufficient to provide wet distillers grain with solubles (WDGS);
drying the wet distillers grain with solubles (WDGS), sufficient to provide dried distillers grain with solubles (DDGS); and
binding the dried distillers grain with solubles (DDGS), sufficient to provide a solid dried distillers grain with solubles (DDGS).

27. The method of claim 26, wherein the biofuel comprises ethanol.

28. The method of claim 26, wherein the biofuel source comprises corn.

29. The method of claim 26, wherein the biofuel source comprises a cellulose source.

30. The method of claim 26, wherein heating comprises burning with a fluidized bed of sand.

31. The method of claim 26, wherein binding comprises pelletizing.

32. The method of claim 26, wherein binding comprises extruding.

33. The method of claim 26, wherein solid DDGS comprises pelletized DDGS.

34. The method of claim 26, wherein the solid ash comprises pelletized ash.

35. A method for producing a biofuel, comprising:
fermenting a biofuel source, sufficient to provide a biofuel and a mash mixture;
separating the mixture, sufficient to provide a biofuel and a mash;
separating the mash, sufficient to provide wet distillers grain (WDG) and a syrup; and
heating the syrup with a fluidized bed, sufficient to provide ash and heat;
wherein the heat is recovered for use in powering plant processes.

36. The method of claim 35, wherein heating the syrup comprises burning with a fluidized bed of sand.

37. A method of generating revenue from a biofuel manufacturing process, comprising:
producing biofuel and one or more byproducts from a biofuel process;
transporting the biofuel for sale to customers;
binding the one or more byproducts, sufficient to form solid byproducts;
packaging the solid byproducts; and
transporting the solid byproducts for sale to customers.
